(19) United States
(12) Patent Application Publication
(10) Pub. No.: US 2014/0046668 A1
(43) Pub. Date: Feb. 13, 2014

(54) CONTROL METHOD AND VIDEO-AUDIO PLAYING SYSTEM

(71) Applicant: Chih-Wen Huang, New Taipei City (TW)

(72) Inventor: Chih-Wen Huang, New Taipei City (TW)

(73) Assignee: WISTRON CORPORATION, New Taipei City (TW)

(21) Appl. No.: 13/607,821

(22) Filed: Sep. 10, 2012

(30) Foreign Application Priority Data
Aug. 9, 2012 (TW) 101128842

(51) Int. Cl. G10L 11/00

(52) U.S. Cl. 704/270; 704/E11.001

(57) ABSTRACT

A control method for a video-audio playing system receiving a video-audio streaming signal is provided. The video-audio streaming signal includes at least a channel-program information. The control method comprises receiving a speech signal and analyzing the speech signal to obtain an acoustic feature of the speech signal. According to the acoustic feature, a speech recognition is performed to determine one of the channel-program information corresponds to the acoustic feature. According to the determined channel-program information, the video-audio playing system executes an operation corresponding to the channel-program information.

### CROSS-REFERENCE TO RELATED APPLICATION

This application claims the priority benefit of Taiwan application serial no. 101128842, filed on Aug. 9, 2012. The entirety of the above-mentioned patent application is hereby incorporated by reference herein and made a part of this specification.

### BACKGROUND OF THE INVENTION

1. Field of Invention

The present invention relates to a control method and a video-audio playing system. More particularly, the present invention relates to a method for voice controlling a video-audio playing system and a video-audio playing system.

2. Description of Related Art

Currently, the user watching programs on the television uses remote control to switch channels. However, with the improvement of the maturity of the speech recognition technology, the technicians of the television development start to combine the speech recognition and the television technology in order to simplify the complexity for operating the television due to the increment of the television programs.

The current speech recognition is that the keys on the remote control are regarded as the command set to be recognized. The user needs to be familiar with the command set so as to successfully control the video-audio playing system (television) through the voice input and the speech recognition. For instance, the user can voice input the channel number or the speech commands such as “the previous channel/the next channel” to switch channels. However, by using this simple speech recognition, the user needs to remember the channel numbers or to repeatedly voice input the speech commands such as “the previous channel/the next channel” and this kind of voice input is not oral for the user. Thus, it is not convenient for the user to use voice input. Moreover, with the increasing of the programs, the number of the channels is increased. Therefore, the program selection becomes more complex, which leads to the increment of the operation difficulty of the voice input.

### SUMMARY OF THE INVENTION

The present invention provides a control method capable of improving the voice input to be more oral input so as to increase the usage convenience.

The invention provides a video-audio playing system capable of using voice input to control the video-audio playing system so as to decrease the operation difficulty of the voice input.

The invention provides a control method for a video-audio playing system receiving a video-audio streaming signal, wherein the video-audio streaming signal includes at least a channel-program information. The method comprises obtaining a speech signal and analyzing the speech signal to obtain an acoustic feature of the speech signal. According to the acoustic feature, a speech recognition is performed to determine one of the channel-program information corresponds to the acoustic feature. According to the determined channel-program information, the video-audio playing system executes an operation corresponding to the determined channel-program information.

According to one embodiment of the present invention, the operation includes the video-audio playing system is tuned from a first video-audio channel to which has been tuned to a second video-audio channel corresponding to the obtained channel-program information.

According to one embodiment of the present invention, the speech recognition further comprises a semantic analysis for obtaining an operating action corresponding to the speech signal so that the step that video-audio playing system executes the operation corresponding to the determined channel-program information further refers to the operating action.

According to one embodiment of the present invention, the operating action includes presetting a recording schedule, presetting a device turn-on schedule or pre-schedule a program delivering list.

According to one embodiment of the present invention, based on the determined channel-program information and the operating action, the operation executed by the video-audio playing system includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

According to one embodiment of the present invention, the channel-program information includes a plurality of video-audio channel information and a plurality of video-audio program information corresponding to each of the video-audio channel information.

The invention also provides a video-audio playing system. The video-audio playing system comprises a signal receiver, an acoustic collecting apparatus and a control system. The signal receiver receives a video-audio streaming signal, wherein the video-audio streaming signal includes at least a channel-program information. The acoustic collecting apparatus obtains a speech signal. The control system is coupled to the acoustic collecting apparatus and the signal receiver. The control system comprises a storage device and a processing unit. The storage device stores a computer readable and writable program. The processing unit executes a plurality of the instructions of the computer readable and writable program. The instructions comprise analyzing the speech signal to obtain an acoustic feature of the speech signal. According to the acoustic feature, a speech recognition is performed to determine one of the channel-program information corresponds to the acoustic feature. According to the determined channel-program information, the video-audio playing system executes an operation corresponding to the determined channel-program information.

According to one embodiment of the present invention, the operation includes the video-audio playing system is tuned from a first video-audio channel to which has been tuned to a second video-audio channel corresponding to the obtained channel-program information.

According to one embodiment of the present invention, the speech recognition further comprises a semantic analysis for obtaining an operating action corresponding to the speech signal so that the step that video-audio playing system executes the operation corresponding to the determined channel-program information further refers to the operating action.

According to one embodiment of the present invention, the operating action includes presetting a recording schedule, presetting a device turn-on schedule or pre-schedule a program delivering list.

According to one embodiment of the present invention, based on the determined channel-program information and the operating action, the operation executed by the video-audio playing system includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

According to one embodiment of the present invention, the channel-program information includes a plurality of video-audio channel information and a plurality of video-audio program information corresponding to each of the video-audio channel information.

According to one embodiment of the present invention, the video-audio playing system further comprises a display, wherein the signal receiver and the control system are configured on the display.

According to one embodiment of the present invention, the video-audio playing system further comprises a display, wherein the control system is configured on a portable device and the signal receiver is configured on the display.

According to one embodiment of the present invention, the portable device receives at least a channel program list through a wireless transmission and the instruction of determining the channel-program information corresponding to the acoustic feature further refers to the channel program list and the channel-program information.

Altogether, the channel-program information is extracted from the video-audio streaming signal and the acoustic feature of the obtained speech signal is mapped to the channel-program information so that the channel, the program or the operating instruction corresponding to the speech signal can be accurately determined. In other words, the user can directly speak out the well-known program name or the channel information as the voice input so that the video-audio playing system determines the operation corresponding to the voice input (speech signal) according to the channel-program information extracted from the video-audio streaming signal and executes the operation. Hence, the voice control (speech control) video-audio playing system approaches the oral and intuitional control which greatly increase the operation convenience and decrease the operation difficulty.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing a control method according to one embodiment of the present invention.

FIG. 2 is a schematic diagram showing a channel-program information according to one embodiment of the present invention.

FIG. 3 is a schematic diagram illustrating a video-audio playing system according to one embodiment of the present invention.

FIG. 4 is a schematic diagram illustrating a video-audio playing system according to another embodiment of the present invention.

### DESCRIPTION OF THE PREFERRED EMBODIMENTS

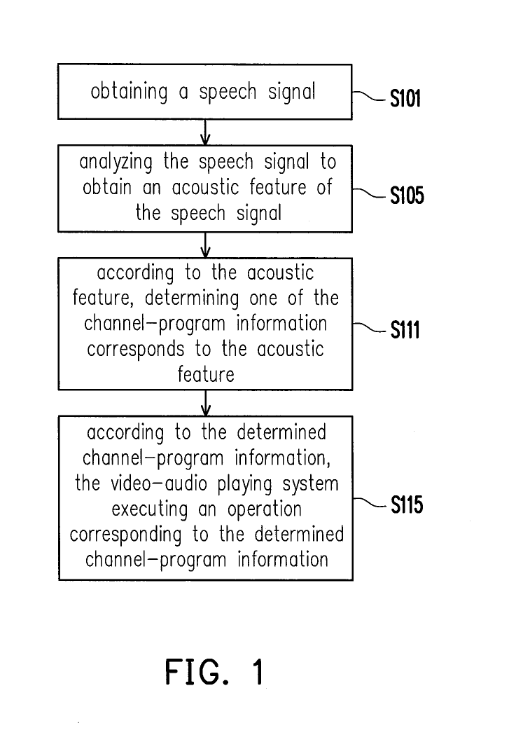

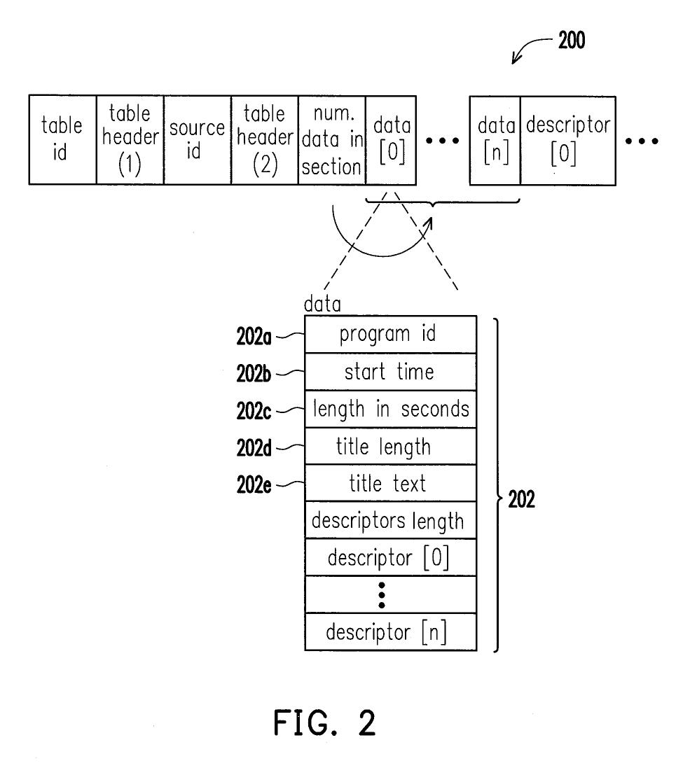

FIG. 1 is a flow chart showing a control method according to one embodiment of the present invention. As shown in FIG. 1, the control method of the present embodiment is used for a video-audio playing system. The video-audio playing system can be, for example, a television, or a digital media player (DMP) or a digital media renderer (DMR) of the digital living network alliance (DLNA). Moreover, the video-audio playing system receives a video-audio streaming signal, wherein the video-audio streaming signal includes at least a channel-program information. Further, the channel-program information comprises a plurality of video-audio channel information and a plurality of video-audio program information corresponding to each of the video-audio channel information. FIG. 2 is a schematic diagram showing a channel-program information according to one embodiment of the present invention. As shown in FIG. 2, taking one (labeled 202) of the video-audio program information corresponding to the channel-program information 200 as an exemplary embodiment, the video-audio program information 202 at least comprises a program id 202a, a program start time 202b, a program length (in time unit/in seconds) 202c, a program title length 202d and a program title text 202e.

In one embodiment, the video-audio playing system further analyzes the received channel-program information to generates command sets for the later performed speech recognition. Table 1 lists the command sets generated by analyzing the channel-program information.

TABLE 1

| Channel Code | Channel Name |
|---|---|
| 2 | Discovery |
| 3 | CNN Today |
| 99 | NBA |
| 21 | Disney |
| 50 | Fox |

In the step S101, the video-audio playing system obtains a speech signal. Then, in the step S105, the video-audio playing system analyzes the speech signal to obtain an acoustic feature of the speech signal. In the step S111, according to the acoustic feature, a speech recognition is performed to determine one of the channel-program information corresponds to the acoustic feature. In one embodiment, a phoneme-based sound model trained by using hidden Markov model (HMM) is used to determine one of the channel-program information corresponds to the acoustic feature. More specifically, in another embodiment, the aforementioned steps S105 and S111, for example, refer to the command sets listed in the Table 1 and the phoneme-based sound model and utilize the Viterbi algorithm to find out a particular channel-program information among the channel-program information, wherein there is a best path between the particular channel-program information and the acoustic feature.

Finally, in the step S115, according to the determined channel-program information, the video-audio playing system executes an operation corresponding to the determined channel-program information. The operation includes that the video-audio playing system is tuned from a first video-audio channel to which has been tuned to a second video-audio channel corresponding to the obtained channel-program information. For instance, while receiving the speech signal which corresponds to the second video-audio channel or the video-audio program information of the second video-audio channel, the video-audio playing system is currently tuning to the first video-audio channel and is delivering the video-audio program broadcasted through the first video-audio channel. Hence, the video-audio playing system is tuned from the first video-audio channel to the second video-audio channel.

In addition, the speech recognition of aforementioned step S111 further comprises a semantic analysis for obtaining an operating action corresponding to the speech signal. Therefore, the step that video-audio playing system executes the operation corresponding to the determined channel-program information further refers to not only the determined channel-program information but also the operating action obtained from the semantic analysis. For instance, the operating action includes presetting a recording schedule, presetting a device turn-on schedule or pre-schedule a program delivering list. More specifically, according to the determined channel-program information and the operating action, the operation executed by the video-audio playing system includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

The aforementioned embodiments describe a control method of the present invention in which, by using the channel-program information contained in the video-audio streaming signal received by the video-audio playing system and the speech recognition, the video-audio playing system can be accurately controlled by the speech signal to perform various operations including switching channels, presetting a recording schedule, presetting a device turn-on schedule or pre-schedule a program delivering list. In the following paragraphs, several embodiments accompanied with drawings are used to describe the video-audio playing system capable of implementing the control method of the present invention.

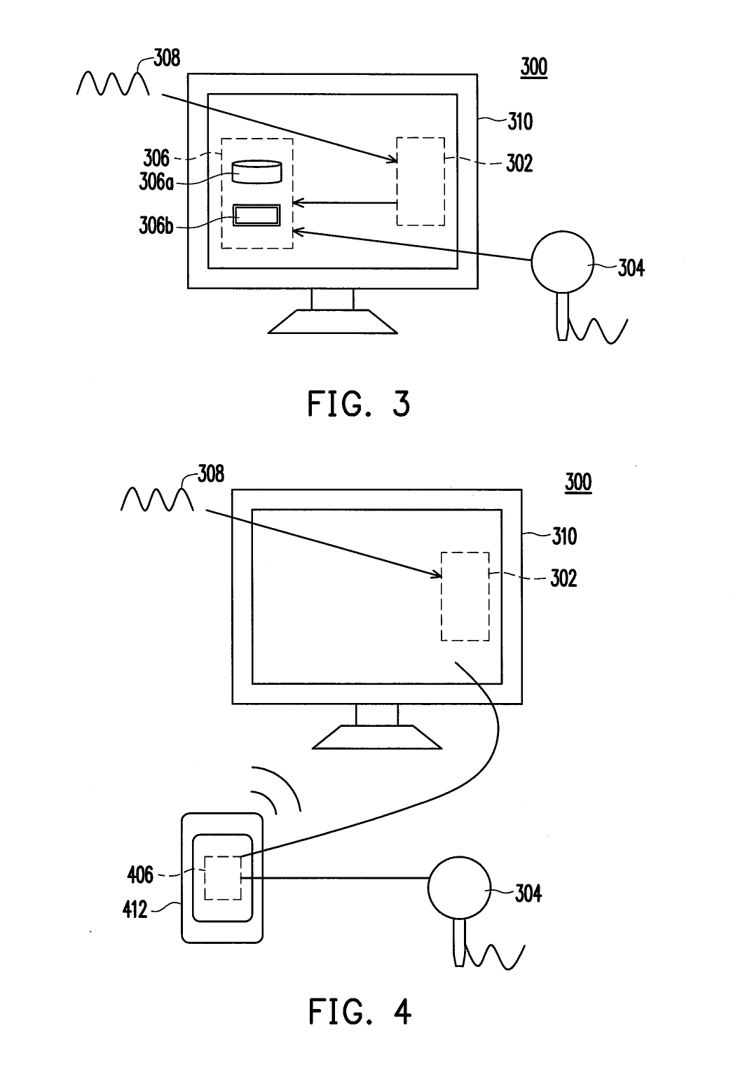

FIG. 3 is a schematic diagram illustrating a video-audio playing system according to one embodiment of the present invention. As shown in FIG. 3, a video-audio playing system 300 of the present embodiment comprises a signal receiver 302, an acoustic collecting apparatus 304, a control system 306 and a display 310. The signal receiver 302 receives a video-audio streaming signal, wherein the video-audio streaming signal includes at least a channel-program information. The channel-program information comprises a plurality of video-audio channel information and a plurality of video-audio program information corresponding to each of the video-audio channel information. The acoustic collecting apparatus 304 can be, for example, a microphone for receiving a sound and converting the sound into a electrical signal such as a speech signal. The control system 306 is coupled to the acoustic collecting apparatus 304 and the signal receiver 302 so that the speech signal obtained by the acoustic collecting apparatus 304 can be transmitted to the control system 306. The display 310 can be, for example, a television capable of delivering video-audio programs.

Moreover, the control system 306 further comprises a storage device 306a and a processing unit 306b. The storage device 306a stores a computer readable and writable program and the processing unit 306b executes a plurality of instructions of the computer readable and writable program. These instructions include analyzing the speech signal to obtain an acoustic feature of the speech signal (as shown in the step S105 of the previous embodiment), performing the speech recognition according to the acoustic feature to determine one of the channel-program information corresponding to the acoustic feature (as shown in step S111 of the previous embodiment) and executing an operation corresponding to the determined channel-program information according to the determined channel-program information (as shown in step S115 of the previous embodiment). Further, in one embodiment, the method for determining one of the channel-program information corresponding to the acoustic feature can, for example, utilize the phoneme-based sound model which is trained by the hidden Markov model (HMM) to determine that one of the channel-program information corresponds to the acoustic feature. In another embodiment, the method for determining one of the channel-program information corresponds to the acoustic feature, for example, refers to the command sets listed in the Table 1 (e.g. the command sets generated by the control system analyzing the video-audio streaming signal) and the phoneme-based sound model and utilize the Viterbi algorithm to find out a particular channel-program information among the channel-program information, wherein there is a best path between the particular channel-program information and the acoustic feature. Thus, the particular channel-program information corresponds to the acoustic feature.

Moreover, the aforementioned operation includes, for example, that the video-audio playing system 300 is tuned from a first video-audio channel to which has been tuned to a second video-audio channel corresponding to the obtained channel-program information. For instance, while receiving the speech signal which corresponds to the second video-audio channel or the video-audio program information of the second video-audio channel, the video-audio playing system 300 is currently tuning to the first video-audio channel and is delivering the video-audio program broadcasted through the first video-audio channel. Hence, the video-audio playing system 300 is tuned from the first video-audio channel to the second video-audio channel.

Moreover, the aforementioned speech recognition comprises a semantic analysis for obtaining an operating action corresponding to the speech signal. Therefore, the video-audio playing system 300 (i.e. the processing unit 306b in the control system 306 of the video-audio playing system 300) executes the operation corresponding to the determined channel-program information according to not only the determined channel-program information but also the operating action obtained from the semantic analysis. For instance, the aforementioned operation action includes presetting a recording schedule, presetting a device turn-on schedule or pre-schedule a program delivering list. More specifically, according to the determined channel-program information and the operating action, the operation executed by the video-audio playing system 300 includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

In the present embodiment, the signal receiver 302 and the control system 306 are configured on the display 310. However, the voice control (speech control) video-audio playing system of the present invention is not limited to this configuration. That is, the control system 306 can be configured on the electronic device other than the display 310.

FIG. 4 is a schematic diagram illustrating a video-audio playing system according to another embodiment of the present invention. As shown in FIG. 4, the elements in FIG. 4 which are as same as those in FIG. 3 are labeled with the reference numbers identical to the reference number labeled on the same element in FIG. 3. The difference between the embodiment shown in FIG. 4 and the embodiment shown in FIG. 3 is that the control system 406 of the present embodiment shown in FIG. 4 is configured on a portable device 412 and the signal receiver 302 is configured on the display 310. Further, the portable device 412 can be, for example, a mobile phone, a smart phone, a tablet personal computer, a notebook or any electronic device capable of receiving signals and processing signal. Therefore, after the signal receiver 302 receives the video-audio streaming signal 308, a microprocessor (not shown) which is coupled to the signal receiver 302 and configured on the display 310 extracts the channel-program information from the video-audio streaming signal or analyzes the video-audio streaming signal to generate the command sets (these steps are detailed in the previous embodiment) and transmits the channel-program information or the command sets to the control system 406 configured on the portable device 412. The control system 406 configured on the portable device 412 analyzes the speech signal obtained by the acoustic collecting apparatus 304 to obtain the acoustic feature of the speech signal (as shown in step S105 of the previous embodiment) and performs the speech recognition according to the acoustic feature to determine one of the channel-program information corresponding to the acoustic feature (as shown in step S111 of the previous embodiment) and the microprocessor (not shown) configured on the display 310 executes an operation corresponding to the determined channel-program information (as shown in step S115 of the previous embodiment).

In another embodiment, the portable device 412 can receive at least a channel program list from Internet through a wireless transmission. Thus, the method for determining the acoustic feature corresponding to the channel-program information refers to not only the channel-program information extracted from the video-audio streaming signal but also the content of the channel program list. Also, in the other embodiment, the acoustic collecting apparatus 304 can be configured on the portable device 412.

Altogether, the channel-program information is extracted from the video-audio streaming signal and the acoustic feature of the obtained speech signal is mapped to the channel-program information so that the channel, the program or the operating instruction corresponding to the speech signal can be accurately determined. In other words, the user can directly speak out the well-known program name or the channel information as the voice input so that the video-audio playing system determines the operation corresponding to the voice input (speech signal) according to the channel-program information extracted from the video-audio streaming signal and executes the operation. Hence, the voice control (speech control) video-audio playing system approaches the oral and intuitional control which greatly increase the operation convenience and decrease the operation difficulty.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A control method for a video-audio playing system receiving a video-audio streaming signal, wherein the video-audio streaming signal includes at least a channel-program information, the method comprising:
obtaining a speech signal;
analyzing the speech signal to obtain an acoustic feature of the speech signal;
according to the acoustic feature, performing a speech recognition to determine one of the channel-program information corresponds to the acoustic feature; and
according to the determined channel-program information, the video-audio playing system executing an operation corresponding to the determined channel-program information.

2. The method of claim 1, wherein the operation includes the video-audio playing system is tuned from a first video-audio channel to which has been tuned to a second video-audio channel corresponding to the obtained channel-program information.

3. The method of claim 1, wherein the speech recognition further comprises a semantic analysis for obtaining an operating action corresponding to the speech signal so that the step that video-audio playing system executes the operation corresponding to the determined channel-program information further refers to the operating action.

4. The method of claim 3, wherein the operating action includes presetting a recording schedule, presetting a device turn-on schedule or pre-schedule a program delivering list.

5. The method of claim 3, wherein, according to the determined channel-program information and the operating action, the operation executed by the video-audio playing system includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

6. The method of claim 1, wherein the channel-program information includes a plurality of video-audio channel information and a plurality of video-audio program information corresponding to each of the video-audio channel information.

7. A video-audio playing system, comprising:
a signal receiver, receiving a video-audio streaming signal, wherein the video-audio streaming signal includes at least a channel-program information;
an acoustic collecting apparatus, obtaining a speech signal;
a control system coupled to the acoustic collecting apparatus and the signal receiver, wherein the control system comprise:
a storage device storing a computer readable and writable program;
a processing unit executing a plurality of the instructions of the computer readable and writable program, wherein the instructions comprises:
analyzing the speech signal to obtain an acoustic feature of the speech signal;
according to the acoustic feature, performing a speech recognition to determine one of the channel-program information corresponds to the acoustic feature; and
according to the determined channel-program information, the video-audio playing system executing an operation corresponding to the determined channel-program information.

8. The video-audio playing system of claim 7, wherein the operation includes the video-audio playing system is tuned from a first video-audio channel to which has been tuned to a second video-audio channel corresponding to the obtained channel-program information.

9. The video-audio playing system of claim 7, wherein the speech recognition further comprises a semantic analysis for obtaining an operating action corresponding to the speech signal so that the step that video-audio playing system executes the operation corresponding to the determined channel-program information further refers to the operating action.

10. The video-audio playing system of claim 9, wherein the operating action includes presetting a recording schedule, presetting a device turn-on schedule or pre-schedule a program delivering list.

11. The video-audio playing system of claim 9, wherein, according to the determined channel-program information and the operating action, the operation executed by the video-audio playing system includes presetting a recording schedule for recording a first video-audio program corresponding to the determined channel-program information, presetting a device turn-on schedule for automatically turning on the video-audio playing system to deliver the first video-audio program corresponding to the determined channel-program information at a predetermined time or automatically delivering the first video-audio program at a broadcasting time of the first video-audio program corresponding to the channel-program information.

12. The video-audio playing system of claim 7, wherein the channel-program information includes a plurality of video-audio channel information and a plurality of video-audio program information corresponding to each of the video-audio channel information.

13. The video-audio playing system of claim 7, further comprising a display, wherein the signal receiver and the control system are configured on the display.

14. The video-audio playing system of claim 7, further comprising a display, wherein the control system is configured on a portable device and the signal receiver is configured on the display.

15. The video-audio playing system of claim 14, wherein the portable device receives at least a channel program list through a wireless transmission and the instruction of determining the channel-program information corresponding to the acoustic feature further refers to the channel program list and the channel-program information.
